(19) United States
(12) Patent Application Publication
(10) Pub. No.: US 2023/0390857 A1
(43) Pub. Date: Dec. 7, 2023

(54) ELECTRODE DRESSING SYSTEM FOR SPOT WELDING PRESS-HARDENED STEELS

(71) Applicants: GM GLOBAL TECHNOLOGY OPERATIONS LLC, Detroit, MI (US); Cutter Solutions International, LLC, Hudson, OH (US)

(72) Inventors: Zhenke Teng, Troy, MI (US); Robert Watson, China, MI (US); Russell A. Webster, JR., Marine City, MI (US); Jason M. Brown, Goodrich, MI (US); Joseph Seme, Hudson, OH (US)

(73) Assignees: GM GLOBAL TECHNOLOGY OPERATIONS LLC, Detroit, MI (US); Cutter Solutions International, LLC, Hudson, OH (US)

(21) Appl. No.: 17/805,097

(22) Filed: Jun. 2, 2022

(51) Int. Cl. B23K 11/30; B23B 5/16; B23B 1/00

(52) U.S. Cl. CPC B23K 11/3063; B23B 5/166; B23B 1/00; B23B 2210/00

(57) ABSTRACT

A system for electrode dressing including a cutter with a rim and a center land supported on the rim by a number of flutes defining openings between the flutes. The flutes and the center land define a cutting profile of the cutter. The cutter is configured to rotate about an axis passing through the center land. Cutting edges are disposed on the flutes and are made of a first material having a Vickers hardness (HV) of at least 850 HV, overlaid by a second material having a Vickers hardness of at least 3200 HV. The cutter profile comprises a face cutting profile extending radially outward from the axis that is disposed at an angle of less than six-degrees relative to a radial normal of the cutter.

### INTRODUCTION

The present disclosure relates to tip (cap) dressing of welding electrodes, and more particularly to systems involving tip dressing electrodes in the spot welding of press-hardened steels.

Welding is one of the most common forms of joining components and is used extensively. Spot welding is a resistance welding process that employs copper/copper alloy electrodes to apply pressure and electric current to one or more metal workpieces to generate heat as current passes between the electrodes through the resistive material of the workpiece(s). The heat fuses the workpiece(s) forming a weld as the melted material solidifies after removal of the current.

Spot welding is often used in repetitive welding operations such as welding together automotive body structural components through multiple weld spots. Due to the repeated application of pressure and current through the electrodes, electrode degradation eventually occurs. Geometric and/or metallurgical changes may occur as the electrodes are used. For example, the electrode's tip diameter may increase and/or other the electrodes may undergo other deformation such as mushrooming. Also for example, properties of the electrode's material, especially at the tip surface, may change over time leading to suboptimal current conduction.

To address the degradation of electrodes and extend their useful life, tip dressing may be employed. Electrode tip dressing involves mechanically restoring electrode geometry, such as by material removal. An improperly dressed electrode may result in irregular welds, electrode to workpiece sticking, and other undesirable outcomes. Accordingly, effective tip dressing systems are desirable.

Press-hardened steel (PHS) results from processes that heat and form the steel to its final shape in water cooled dies that quench the material to develop desirable properties. The resulting material may be classified as advanced high-strength steel (AHSS), which is a stable material with a high strength-to-weight ratio. The use of such steel is desirable, particularly where weight is a consideration. The physical characteristics of PHS/AHSS material may present challenges in welding, such as reduced electrode lifespan.

Accordingly, it is desirable to provide systems for tip dressing electrodes in welding applications, including in the spot welding of press-hardened steels. It would also be desirable for such systems to extend the lifespan of electrodes while maintaining quality weld formation. Furthermore, other desirable features and characteristics of the present disclosure will become apparent from the subsequent detailed description and the appended claims, taken in conjunction with the accompanying drawings and the foregoing technical field and background.

### SUMMARY

A system for electrode dressing is disclosed. In a number of embodiments, the system includes a cutter with a rim and a center land supported on the rim by a number of flutes defining openings between the flutes. The flutes and the center land define a cutting profile of the cutter. The cutter is configured to rotate about an axis passing through the center land. Cutting edges are disposed on the flutes and are made of a first material having a Vickers hardness (HV) of at least 850 HV, overlaid by a second material having a Vickers hardness of at least 3200 HV.

In additional embodiments, the second material comprises a coating on the first material of less than ten micrometers in thickness.

In additional embodiments, the cutting profile comprises a face cutting profile extending radially outward from the axis. The face cutting profile is disposed at an angle of less than six-degrees relative to a radial normal of the cutter.

In additional embodiments, the cutter comprises a receiving side surface through which the electrode is received into the cutter. The face cutting profile results in the profile receding away from the receiving side surface when moving radially outward from the axis.

In additional embodiments, a groove is defined in each of the flutes. The grooves are disposed radially outward from the center land.

In additional embodiments, each groove includes a leading end and a trailing end. Between the leading end and the trailing end, the groove becomes progressively wider.

In additional embodiments, the leading end is located closer to the axis relative to the trailing end.

In additional embodiments, the first material comprises high speed tool steel and the second material comprises titanium alloy.

In additional embodiments, an electrode is configured to weld press-hardened steel. The electrode, after welding the press-hardened steel, comprises a weld face with a buildup and intermetallic layer of aluminum silicon copper alloy. The cutter has a harness greater than the buildup and the intermetallic layer.

In additional embodiments, a dressing apparatus includes a tip dresser tool with a drive system and a cutter arm carrying the cutter. The dressing apparatus is configured to drive the cutter to rotate to dress the electrode.

In a number of other embodiments, an electrode dressing system includes an annular rim and a center land supported on the annular rim by flutes defining four openings between the flutes. The flutes and the center land define a cutting profile of the cutter. The cutter is configured to rotate about an axis passing through the center land. Cutting edges are formed on the flutes and comprise a first material having a Vickers hardness (HV) of at least 850 HV overlaid by a second material having a Vickers hardness of at least 3200 HV.

In additional embodiments, the second material comprises a coating deposited on the first material in a thickness of less than ten micrometers.

In additional embodiments, the cutting profile comprises a face cutting profile extending radially outward from the axis. The face cutting profile is convex in character and has sides, each disposed at an angle of less than six-degrees relative to a radial normal of the cutter.

In additional embodiments, the cutter comprises a receiving side surface through which the electrode is received into a cavity of the cutter. The face cutting profile results in the profile receding away from the receiving side surface when moving radially outward from the axis.

In additional embodiments, the electrode has an outer perimeter. The cutter is configured to receive the electrode, and a groove in each of the flutes is disposed radially outward from the center land adjacent the outer perimeter of the electrode.

In additional embodiments, each groove includes a leading end and a trailing end, wherein from the leading end and the trailing end, the groove becomes progressively wider in a radial direction.

In additional embodiments, the leading end is located closer to the axis relative to the trailing end so that the grooves are skewed across their respective flutes.

In additional embodiments, the first material comprises high speed M4 tool steel and the second material comprises beta-phase titanium alloy.

In additional embodiments, the electrode is configured to weld press-hardened steel, and after welding the press-hardened steel, the electrode comprises a weld face with a buildup and intermetallic layer of aluminum silicon copper alloy. The cutter has a harness greater than the buildup and the intermetallic layer.

In a number of additional embodiments, an electrode dressing system includes a cutter with an annular rim and a center land supported on the annular rim by flutes defining four openings between the flutes. The flutes and the center land define a cutting profile of the cutter. The cutter is configured to rotate about an axis passing through the center land. Cutting edges are defined on the flutes, wherein the cutting edges comprise a first material having a Vickers hardness (HV) of at least 850 HV overlaid by a second material having a Vickers hardness of at least 3200 HV. The cutting profile comprises a face cutting profile extending radially outward from the axis. The face cutting profile is convex in character and has sides each of which is disposed across the axis from the other. The sides are each disposed at an angle of less than six-degrees relative to a radial normal of the cutter.

### DESCRIPTION OF THE DRAWINGS

The exemplary embodiments will hereinafter be described in conjunction with the following drawing figures, wherein like numerals denote like elements, and wherein:

FIG. 1 is a schematic illustration of a welding system, in accordance with various embodiments;

FIG. 2 is a magnified, schematic, sectional illustration of the weld face of a used welding tip of the welding system of FIG. 1, in accordance with various embodiments;

FIG. 3 is a schematic illustration of a tip dressing system of the welding system of FIG. 1, in accordance with various embodiments;

FIG. 4 is a plan view of the dressing tool of the tip dressing apparatus of FIG. 3, in accordance with various embodiments;

FIG. 5 is a detail illustration of the face of the cutter of the tip dressing apparatus of FIG. 3, in accordance with various embodiments;

FIG. 6 is a cross sectional illustration taken generally through the line 6-6 in FIG. 5, in accordance with various embodiments;

FIG. 7 is a cross sectional illustration similar to that of FIG. 6, with an electrode cap inserted into the cutter, in accordance with various embodiments;

FIG. 8 is fragmentary, magnified, schematic illustration of a cross section of the face of the cutter of FIG. 5, in accordance with various embodiments; and

FIG. 9 illustrates the face profile of the cutter of FIG. 5, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

As disclosed herein, systems optimize the dressing of electrodes using a cutter, including for electrodes used in spot welding of PHS. It has been found as part of the subject matter of this disclosure that during spot welding of PHS, including PHS with a coating such as aluminum-silicon (AlSi), the coating alloys with the copper electrodes and forms a hard intermetallic layer (IML) with a hardness close to typical cutter material itself. This IML, has been found, as part of this disclosure, to resist effective removal leading to sub-optimized dressing of the electrode and reduced cutter life. The physical properties of electrodes significantly affect characteristics such as weld quality and surface appearance and so proper dressing is needed. As disclosed herein, a dressing cutter, in general, employs a substrate material with a tailored hardness, further hardened by a thin, high-strength coating. The cutter may also include an optimized cutting-angle design at the cutter's interior to improve dressing, including in the presence of the IML. The effectiveness of the cutter disclosed herein has been demonstrated to significantly improve the electrode dressing quality in PHS steel welding applications and leads to increased cutter life.

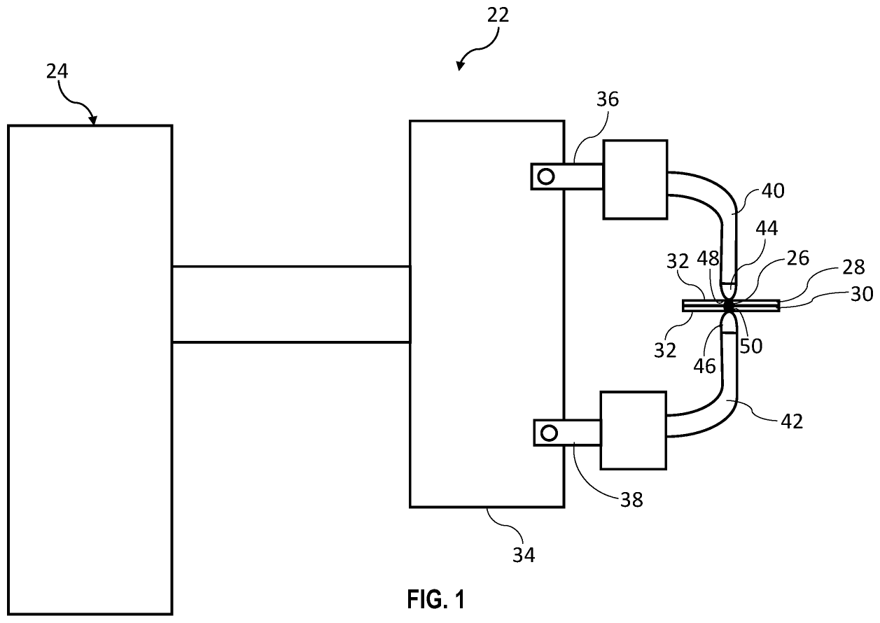

Referring to FIG. 1, a schematic illustration of a welding system 22 shows a welding apparatus 24 forming a weld 26 in stacked sheets 28, 30 of PHS. In some embodiments, instead of welding two sheets together, the welding system 22 may form the weld 26 in one sheet, or between one sheet and another component (not shown). In the current embodiment, the welding apparatus 24 is a spot welding machine. In other embodiments, the welding apparatus 24 is any type that uses electrodes requiring periodic dressing, such as resistance-type welders. The welding apparatus 24 includes an articulating weld head 34 with weld arms 36, 38. The weld arms 36, 38 are moveable relative to one another to open and to close to receive/release and to apply pressure to the stacked sheets 28, 30. The amount of pressure applied may be limited by the characteristics of the cutter. The weld arms 36, 38 include electrodes 40, 42 respectively, which conduct electric current applied by the welding apparatus 24 to form the weld 26. The electrodes 40, 42 may also be referred to as electrode shanks due to their shape. When connected with the sheets 28, 30, the electrodes 40, 42 pass a current through the sheets 28, 30 to heat the spot where they connect. The material of the sheets 28, 30 melts and fuses together due to the resistance generated heat.

In the current embodiment, the sheets 28, 30 are formed of PHS and include a coating 32, such as of AlSi. In other embodiments, another coating material may be used. For purposes of the current disclosure, the coating 32 is one that forms a hard layer on the electrodes 40, 42 when exposed to electrical current from the welding apparatus 24. The coating 32 may be applied by means such as hot-dipping or by another appropriate process. The electrodes 40, 42 may include caps 44, 46 respectively, that contact the sheets 28, 30. The caps 44, 46 are a part of the electrodes 40, 42 and are removeable, such as by being threaded to the electrodes 40, 42 for replacement due to the likelihood of their deterioration after repeated welding operations.

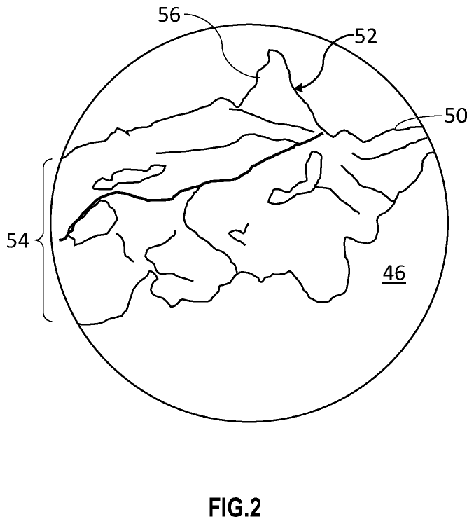

The electrode caps 44, 46 come into contact with the PHS sheets 28, 30 at the coating 32. It has been discovered that instead of deforming (mushrooming) or depleting of the caps 44, 46, which is heretofore typical, repeated welding cycles in PHS applications result in a buildup of material on the caps 44, 46. In addition, the buildup accumulates only on the weld faces 48, 50 that contact the sheets 28, 30, rather than on the entire caps 44, 46 such as at their periphery. FIG. 2 schematically illustrates the buildup 52 effect at the weld face 50 of the cap 46. The buildup 52 includes an IML 54 and added material 56. In the current embodiment, the IML 54 and added material 56 comprise an aluminum silicon copper alloy (AlSiCu) that has a Vickers hardness (Vickers pyramid number “HV”) of over 600 HV. The caps 44, 46 are made of a copper/copper alloy material that, without the buildup 52, is a relatively soft, malleable, and ductile material. Accordingly, dressing the caps 44, 46 is generally readily accomplished. For example, copper may generally have a hardness of 50-150 HV. For dressing copper, an overly aggressive cutting tool would overconsume the material of the copper leading to short cap life. As a result, systems for dressing the caps 44, 46 as disclosed herein include aspects that effectively remove the buildup 52 without an undesirable consumption rate of the base copper of the caps 44, 46.

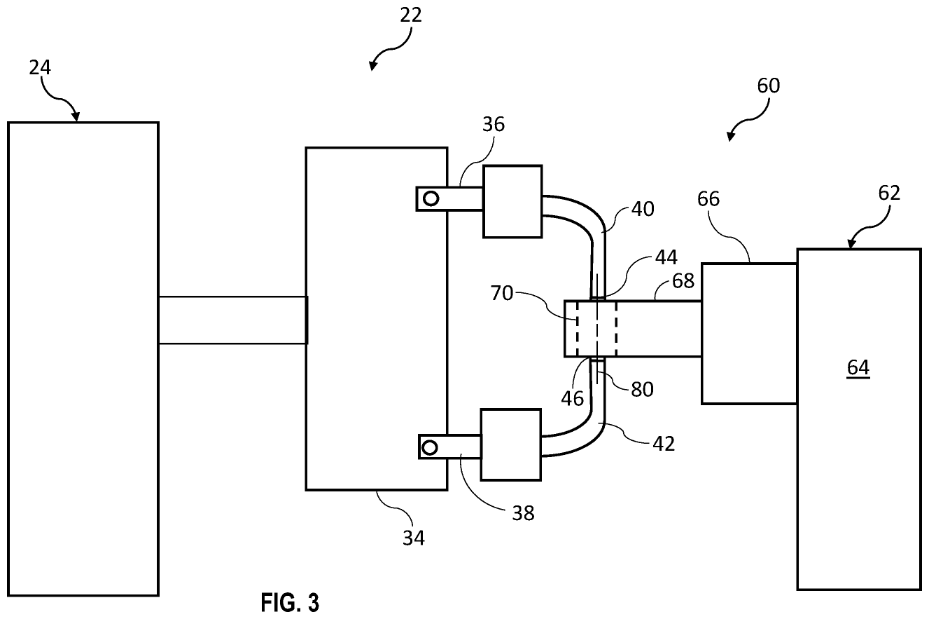

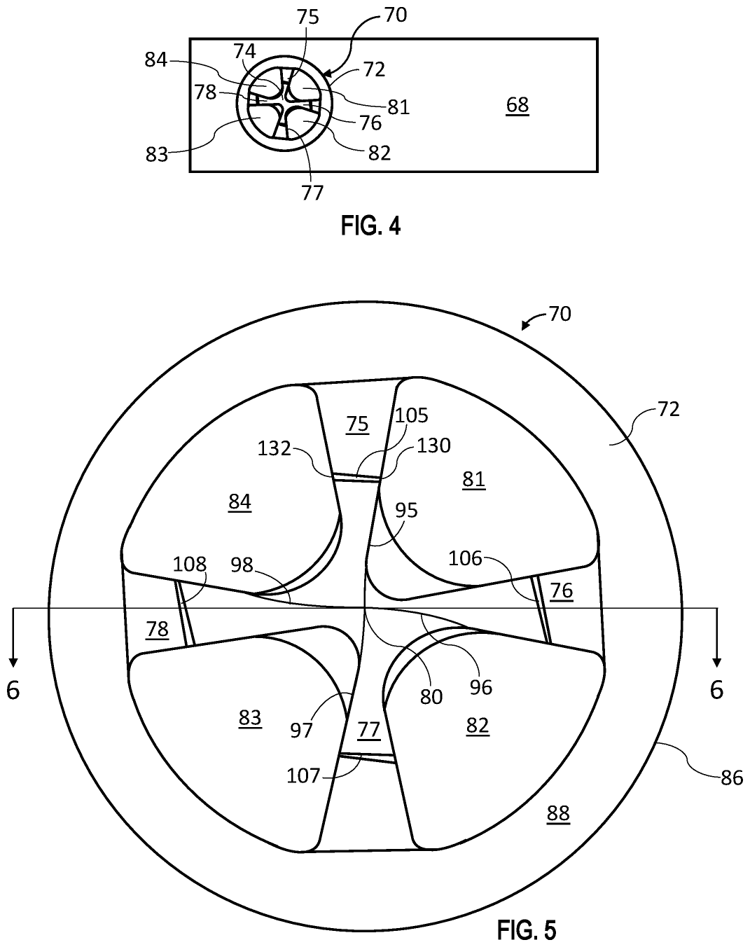

As shown schematically in FIG. 3, a dressing system 60 includes the welding apparatus 24 and a dressing apparatus 62. The dressing apparatus 62 includes a tip dresser tool 64 with a drive system 66 and a cutter arm 68. The dressing apparatus 62 is configured to drive a cutter 70 to rotate and to dress the cap 44, in this case. The cutter arm 68 may have a dual faced cutter to dress both caps 44, 46 simultaneously, or may be inverted to dress the cap 46 after dressing the cap 44. The cutter arm 68 is illustrated in isolation in FIG. 4, from a top perspective as disposed in FIG. 3. The drive system 66 may include gears and linkages (not shown) to rotate the cutter 70. A representative dressing system is described in U.S. Pat. No. 11,224,933, granted Jan. 18, 2022, which is commonly assigned, and which is specifically incorporated herein by reference.

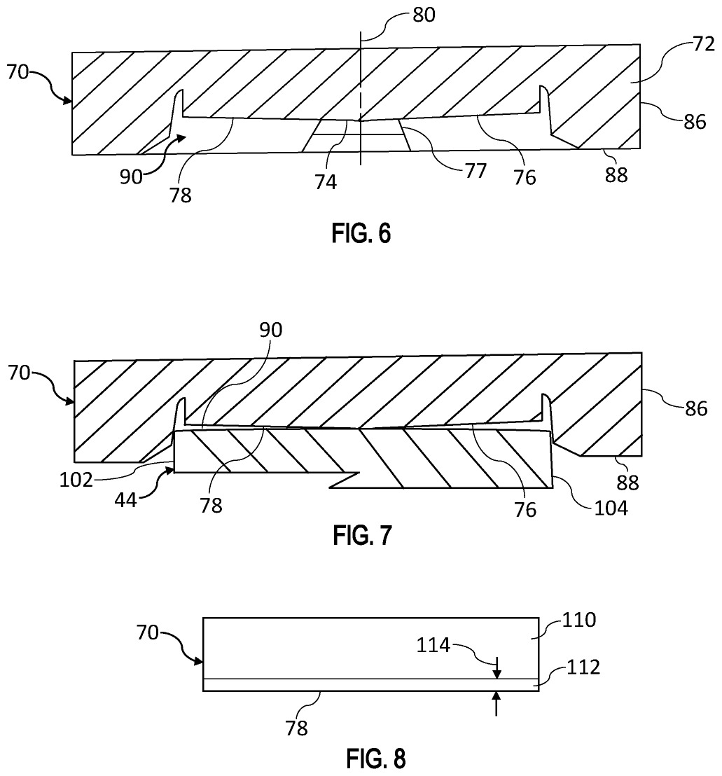

The cutter 70 includes an annular rim 72 with a center land 74 supported on the annular rim 72 by four flutes 75-78, in this embodiment. This results in four openings 81-84 extending axially through the cutter 70. Axially refers to an axis 80, shown in FIG. 3, about which the cutter 70 rotates. The cutter 70 is shown in isolation and in an enlarged view in FIG. 5, and in cross section in FIG. 6, and engaging a cap 44 in FIG. 7.

Referring to FIGS. 5-7 concurrently, the cutter 70 is shaped to receive (FIG. 7), and dress the caps 44, 46 and as such, includes a receptive cavity shape. The annular rim 72, which may be another shape, has an outer perimeter 86 and a receiving side surface 88 through which the cap 44 (or 46) is received. The center land 74 is recessed into the cutter 70 relative to the receiving side surface 88 forming a cavity 90 within which the cap 44 is received as shown in FIG. 7. Each of the flutes 75-78 has a respective cutting edge 95-98 for removing material from the cap 44 as the cutter is rotated about the axis 80, while the cap 44, 46 is held stationary. In the current embodiment, the cutter 70 is rotated clockwise as viewed in FIG. 5 placing the cutting edges 95-98 at the leading side of their respective flutes 75-78 when encountering the cap 44, 46. The cutting edges 75-78 each extend onto the center land 74 to the axis 80 and therefrom, radially outward to the annular rim 72 so that the cutter 70 dresses the cap 44 at its tip/weld face 100 and at its rim/side 102 adjacent the weld face 100 via a cutting surface 79. Each flute 75-78 of the cutter 70 includes a groove 105-108 spaced radially outward from the axis 80 as further described below.

A snapshot of the cutter 70 at the cutting edge 95 is schematically shown in FIG. 8. The base material 110 of the cutter 70 is chosen to have a hardness of at least 850 HV. For example, the base material 110 is a high speed tool steel such as M4. The cutter 70 has a layer 112 as the coating 32 overlaying the base material 110 at its cutting surface 79 that has a hardness of at least 3200 HV. In the current embodiment, the layer 112 is a thin coating with a thickness 114 of less than ten micrometers (μm). The material of the layer 112 may be a beta-phase titanium alloy such as titanium with one or more of molybdenum, vanadium, niobium, tantalum, zirconium, manganese, iron, chromium, cobalt, nickel and/or copper. The layer 112 improves surface microhardness of the cutter 70, and has been found to improve cutting with less galling and improved life of the cutter 70. The hardness of the base material 110 coupled with that of the surface layer 112 has been demonstrated to effectively remove the buildup 52 created by welding PHS including PHS with AlSi coating. The combination of the base material 110 and the surface layer 112 optimizes dressing as demonstrated by an improved consumption rate of 5-10 times or more, meaning the cutter 70 effectively removes material over an extended life.

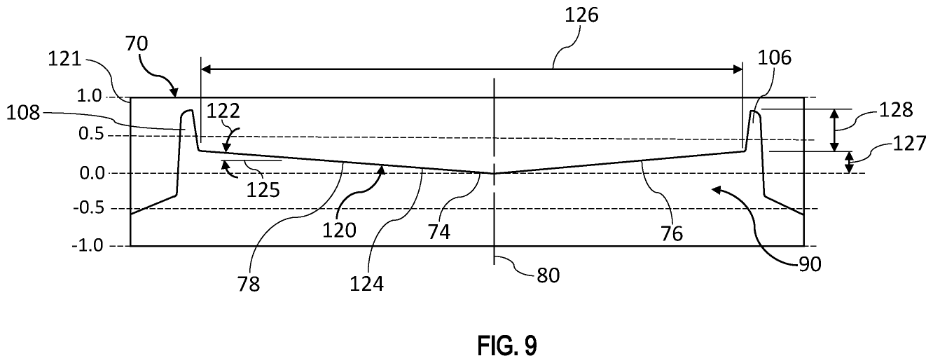

Referring to FIG. 9, a profile 120 trace of the cutter 70 is shown taken across the axis 80 and through the flutes 78 and 76. Depth of the cavity 90 is indicated in millimeters on the left side 121 relative to zero at the intersection of the profile 120 with the centerline Each of the flutes 75-78, as demonstrated by those shown in FIG. 9 (flutes 76 and 78), recedes into the cutter 70 from the land 74 moving radially outward away from the axis 80. The cutting angle 122 at which the flutes 75-78, and specifically a weld face cutting profile 124 is oriented is at a maximum of six degrees relative to a radial normal 125 for the distance from the axis 80 radially outward to the grooves 106, 108. The weld face cutting profile 124 is convex in character between the grooves 106, 108. The radial normal 125 is a reference line extending radially across the cutter 70 normal (at ninety-degrees) relative to the axis 80. The weld face cutting profile 124 extends a distance 126 across the profile 120. The cutting-angle 122 design at the interior of the cutter 70 within the cavity 90 enables increased cutting force to be applied to the caps 44, 46 and directs the cutting action to focus on the weld face 100 of the caps 44, 46, as opposed to their sides, which would be the case if mushrooming were the primary concern.

As shown in the profile 120, the grooves 105-108 (106 and 108 shown in FIG. 9), recede into the cutter 70 sharply in comparison to the six-degree cutting angle 122. For example, the weld face cutting profile 124 recedes a distance 127 and the groove 106 recedes a distance 128. The distance 127 is approximately 0.25 mm in depth over a radial distance of greater than 3.0 mm, while the distance 128 is over 0.50 mm in depth over a radial distance of less than 0.30 mm. These grooves 105-108 assist with chip/offal rejection during cutting to keep the cut clean and beneficially defines the weld face 100 of the caps 44, 46. A result is that the cutter 70 focuses cutting action at the weld face 100 and addresses the buildup 52 by effectively removing the hard material without excessively consuming the copper of the caps 44, 46.

Each of the grooves 105-108 is positioned near/adjacent the outer periphery 104 of the cap 44 when received in the cavity 90 as shown in FIG. 7. As best illustrated in FIG. 5, each of the grooves 105-108 tapers away from its respective cutting edge 95-98 across its respective flute 75-78 and is disposed at an angular deviation relative to the axis 80. For example, the groove 105 includes a leading end 130 and a trailing end 132. Between the leading end 130 and the trailing end 132, the groove 105 becomes increasingly wider when viewed in the direction of the axis 80. In addition, the leading end 130 is located closer to the axis 80 relative to the trailing end 132 in a skewed angled orientation relative to the axis 80. The result is that the grooves 105-108 effectively peel off chips and other offal as the cutter 70 operates.

The effectiveness of the cutter 70 has been optimized to effectively dress electrodes/caps in PHS welding applications. However, the cutter 70 is not limited to those applications but has wider applicability where difficult dressing challenges exist. As noted above, consumption rate has been demonstrated as significantly improved. Table 1 below provides details of this improvement by comparing the results of a prior art cutter in the middle column to the results of the cutter 70 of the current disclosure in the third column for a series of nineteen consecutive cuts listed in the first column. A “cut” of column 1 means how much material a single tip dress removes in millimeters to completely remove cap contamination. The rows means a total of 18 cuts (dressings) were conducted. As demonstrated, the total material removed over the series of nineteen cuts was 0.505 mm for the prior art cutter shown in the second column, and 1.942 mm for the cutter 70 shown in the third column. For cut numbers 1-18, the cutter 70 removed substantially more material than the prior art cutter, whose effectiveness quickly degraded. Degradation of the prior art cutter of column 2 is rapid relative to that of the cutter 70 of column 3. In sum, the cutter 70 is more aggressive and has a much longer serviceable life and maintains consistent effectiveness for the eighteen cuts in the series. The ability to effectively remove the buildup and IML, demonstrates the benefits of the current cutter 70 in a number of applications.

TABLE 1

| | Prior Art | Cutter 70 |
|---|---|---|
| Cut No. | (mm) | (mm) |
| 1 | 0.220 | 0.235 |
| 2 | 0.017 | 0.146 |
| 3 | 0.014 | 0.136 |
| 4 | 0.034 | 0.126 |
| 5 | 0.021 | 0.122 |
| 6 | 0.017 | 0.102 |
| 7 | 0.002 | 0.107 |
| 8 | 0.006 | 0.091 |
| 9 | 0.024 | 0.106 |
| 10 | 0.017 | 0.089 |
| 11 | 0.023 | 0.106 |
| 12 | 0.006 | 0.107 |
| 13 | 0.011 | 0.102 |
| 14 | 0.014 | 0.076 |
| 15 | 0.018 | 0.064 |
| 16 | 0.025 | 0.084 |
| 17 | 0.011 | 0.068 |
| 18 | 0.025 | 0.075 |
| Total | 0.505 | 1.942 |

As disclosed herein, the dressing cutter 70 employs a substrate material with a tailored hardness, further hardened by a thin, high-strength coating. The cutter 70 may also include an optimized cutting-angle design at the cutter interior to improve dressing, including in the presence of the IML. The effectiveness of the cutter disclosed herein has been demonstrated to significantly improve the electrode dressing quality in PHS steel welding applications and leads to increased dressing cutter life.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. An electrode dressing system comprising a cutter including:
a rim;
a center land supported on the rim by a number of flutes defining openings between the number of flutes, wherein the number of flutes and the center land define a cutting profile of the cutter, the cutter configured to rotate about an axis passing through the center land; and
cutting edges on the number of flutes, wherein the cutting edges comprise a first material having a Vickers hardness (HV) of at least 850 HV overlaid by a second material having a Vickers hardness of at least 3200 HV.

2. The electrode dressing system of claim 1, wherein the second material comprises a coating on the first material of less than ten micrometers in thickness.

3. The electrode dressing system of claim 1, wherein the cutting profile comprises a face cutting profile extending radially outward from the axis, wherein the face cutting profile is disposed at an angle of less than six-degrees relative to a radial normal of the cutter.

4. The electrode dressing system of claim 3, wherein the cutter comprises a receiving side surface through which the electrode is received into the cutter, wherein the face cutting profile results in the profile receding away from the receiving side surface when moving radially outward from the axis.

5. The electrode dressing system of claim 1, comprising a groove in each of the number of flutes, wherein the grooves are disposed radially outward from the center land.

6. The electrode dressing system of claim 5, wherein each groove includes a leading end and a trailing end, wherein between the leading end and the trailing end the groove becomes progressively wider.

7. The electrode dressing system of claim 5, wherein the leading end is located closer to the axis relative to the trailing end.

8. The electrode dressing system of claim 1, wherein the first material comprises high speed tool steel and the second material comprises titanium alloy.

9. The electrode dressing system of claim 1, comprising an electrode, wherein the electrode is configured to weld press-hardened steel, wherein the electrode, after welding the press-hardened steel, comprises a weld face with a buildup and intermetallic layer of aluminum silicon copper alloy, wherein the cutter has a harness greater than the buildup and the intermetallic layer.

10. The electrode dressing system of claim 1, comprising an electrode and a dressing apparatus that includes a tip dresser tool with a drive system and a cutter arm carrying the cutter, wherein the dressing apparatus is configured to drive the cutter to rotate to dress the electrode.

11. An electrode dressing system comprising a cutter including:
an annular rim;
a center land supported on the annular rim by flutes defining four openings between the flutes, wherein the flutes and the center land define a cutting profile of the cutter, the cutter configured to rotate about an axis passing through the center land; and
cutting edges on the flutes, wherein the cutting edges comprise a first material having a Vickers hardness (HV) of at least 850 HV overlaid by a second material having a Vickers hardness of at least 3200 HV.

12. The electrode dressing system of claim 11, wherein the second material comprises a coating deposited on the first material in a thickness of less than ten micrometers.

13. The electrode dressing system of claim 11, wherein the cutting profile comprises a face cutting profile extending radially outward from the axis, wherein the face cutting profile is convex in character and has sides each disposed at an angle of less than six-degrees relative to a radial normal of the cutter.

14. The electrode dressing system of claim 13, wherein the cutter comprises a receiving side surface through which the electrode is received into a cavity of the cutter, wherein the face cutting profile results in the profile receding away from the receiving side surface when moving radially outward from the axis.

15. The electrode dressing system of claim 11, comprising an electrode with an outer perimeter, wherein the cutter is configured to receive the electrode, and comprising a groove in each of the flutes, wherein the grooves are disposed radially outward from the center land adjacent the outer perimeter of the electrode.

16. The electrode dressing system of claim 15, wherein each groove includes a leading end and a trailing end, wherein from the leading end and the trailing end, the groove becomes progressively wider in a radial direction.

17. The electrode dressing system of claim 15, wherein the leading end is located closer to the axis relative to the trailing end so that the grooves are skewed across their respective flutes.

18. The electrode dressing system of claim 11, wherein the first material comprises high speed M4 tool steel and the second material comprises beta-phase titanium alloy.

19. The electrode dressing system of claim 11, comprising an electrode, wherein the electrode is configured to weld press-hardened steel, wherein the electrode, after welding the press-hardened steel, comprises a weld face with a buildup and intermetallic layer of aluminum silicon copper alloy, wherein the cutter has a harness greater than the buildup and the intermetallic layer.

20. An electrode dressing system comprising a cutter including:
an annular rim;
a center land supported on the annular rim by flutes defining four openings between the flutes, wherein the flutes and the center land define a cutting profile of the cutter, the cutter configured to rotate about an axis passing through the center land; and
cutting edges on the flutes, wherein the cutting edges comprise a first material having a Vickers hardness (HV) of at least 850 HV overlaid by a second material having a Vickers hardness of at least 3200 HV,
wherein the cutting profile comprises a face cutting profile extending radially outward from the axis, wherein the face cutting profile is convex in character and has sides each disposed across the axis from the other, and the sides each disposed at an angle of less than six-degrees relative to a radial normal of the cutter.
